(19) United States
(12) Patent Application Publication
(10) Pub. No.: US 2005/0195690 A1
(43) Pub. Date: Sep. 8, 2005

(54) Standard time signal receiving time device and decoding method of time code signal

(75) Inventor: Takayuki Kondo, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 10/984,892

(22) Filed: Nov. 10, 2004

(30) Foreign Application Priority Data
Mar. 5, 2004 (JP) 2004-061763

(51) Int. Cl. H04B 1/69

(52) U.S. Cl. 368/47

(57) ABSTRACT

In a radio controlled clock and a decoding method of a time code signal, the time code signal can be accurately decoded irrespective of the mixture of noises and the deterioration of a radio wave signal receiving situation, and arithmetic processing is simple. A standard time signal is received and the time code signal superposed on this standard time signal is sampled at an interval of 50 ms and is stored to a memory. The stored sampling data are formed as a list in a data group every one second (20 samples). The plurality of data groups formed as a list are added every each sampling point, and a point for maximizing an increase change of the adding result is set to a synchronizing point of the sampling. Further, the correlation of the sampling data group and a code template pattern is calculated and a code shown by the sampling data group is judged.

### BACKGROUND OF THE INVENTION

1. Field of the Invention

The present invention relates to a standard time signal receiving time device (hereinafter simply called a “radio controlled clock”) that performs time calibration by using a received a standard time signal and a decoding method of a time code signal superposed on the carrier wave of the standard time signal.

2. Description of the Related Art

The time code signal indicating the Japanese standard time is continuously transmitted by a long radio wave from two domestic signal transmitting stations of the Kyushu long wave station and the Fukushima long wave station managed and controlled by the Communication General Institute of Japan as an independent corporation. Hereinafter, such a long radio wave is called a “standard time signal”. With respect to the standard time signal transmitted presently, two radio waves are used, of which the frequencies of the carrier waves are 40 kHz and 60 kHz respectively. Each of the above-described two signal transmitting stations transmits respective one of the two standard time signals of different carrier wave frequencies.

The carrier wave of the standard time signal is modulated in amplitude by a pulse series of the time code signal of the Japanese standard time converted into a digital code of a predetermined format. In this connection, the pulse series of the time code signal indicating the Japanese standard time is constructed by one frame of 60 bits/minute. A calendar and time information such as year, month, day, hour, minute, etc. are included within such one frame. A bit rate of the pulse series of this time code signal is determined as one bit/minute.

The above time information is coded by a BCD code in the time code signal. Each digit of such a BCD code is expressed by a combination of binary codes of “0” and “1”. Further, a “marker code” is included as a synchronous signal for indicating the boundary of each time information in the time code signal. Therefore, the shape of a pulse waveform corresponding to each code is determined as follows in the pulse series constituting the time code signal so as to discriminate each code such as the binary codes, the marker code, etc. In the following description, “H” is set to show a high level of the pulse waveform, and “L” is set to show its low level. Marker code pulse: “H” of 0.2 second and “L” of 0.8 second

Binary “1” code pulse: “H” of 0.5 second and “L” of 0.5 second

Binary “0” code pulse: “H” of 0.8 second and “L” of 0.2 second.

As mentioned above, the bit rate of the pulse included in the time code signal is one bit/second. Accordingly, all the time widths of the above respective codes are unchangingly “H-interval+L-interval=one second”.

An object of the radio controlled clock is to receive such a standard time signal and decode and regenerate the time code signal superposed on this standard time signal and display exact time information synchronized with the Japanese standard time. Therefore, it is necessary to faithfully decode each code pulse included in the above time code signal. For example, an oscillating circuit using a crystal oscillator is built in the radio controlled clock in consideration of such necessity, and the time code signal is decoded with high accuracy.

However, in the real reception of the standard time signal, there is a fear that a noise signal is superposed on the receiving radio wave by sferics noises or generation noises from a device such as a car, a home electric appliance product, etc., and bit synchronization for detecting a rise starting point of the code pulse included in the time code signal becomes inaccurate. Further, there is also a case in which the signal receiving state of the radio wave becomes worse by an arranging environment of the radio controlled clock and its signal receiving antenna and the pulse waveform of the received and regenerated time code signal is distorted.

A technique as described in JP-A-2003-215277 (patent literature 1) is conventionally disclosed as such a signal receiving fault countermeasure. However, in the prior art, for example, additional processing for sampling an integral value of the time code signal pulse generated on the basis of the standard time signal every predetermined time and discriminating the code, etc. is performed and its arithmetic calculation becomes complicated so that the calculating amount tends to be increased. Therefore, a computer having large processing ability is required in the radio controlled clock taking the fault countermeasure. Further, since it is necessary to perform the increased arithmetic processing by a high speed clock, product cost is raised and electric power consumption is increased.

### SUMMARY OF THE INVENTION

The present invention is made to solve such problems and provides a radio controlled clock and a decoding method of the time code signal in which the time code signal can be accurately decoded irrespective of the mixture of noises and the deterioration of a radio wave signal receiving situation, and the arithmetic processing is simple.

In accordance with features of the present invention, a standard time signal receiving time device for decoding a time code signal as a pulse signal constructed by a series of pulses each indicating a code by its pulse width and obtained from a standard time signal has a sampling component for sampling said time code signal every sampling interval and generating a plurality of sampling data; an adding component for adding said plurality of sampling data every said each sampling interval and generating the sampling data adding value every each sampling interval; and a reference point determining component in which the position of the sampling interval for maximizing the difference of a pair of said sampling data adding value corresponding to the respective sampling intervals adjacent to each other is determined as a bit synchronizing point.

Further, in accordance with another features of the present invention, a decoding method of a time code signal for decoding the time code signal as a pulse signal constructed by a series of pulses each indicating a code by its pulse width from a standard time signal has a sampling step for sampling said time code signal every sampling interval and generating a plurality of sampling data; an adding step for adding said plurality of sampling data every said each sampling interval and generating the sampling data adding value every each sampling interval; and a reference point determining step in which the position of the sampling interval for maximizing the difference of a pair of said sampling data adding value corresponding to the respective sampling intervals adjacent to each other is determined as a bit synchronizing point.

### BRIEF DESCRIPTION OF THE DRAWINGS

FIG. 1 is a block diagram showing the construction of a standard time signal receiving time device in the present invention.

FIG. 2 is a time chart showing a pulse waveform of each code constituting a time code signal.

FIG. 3 is an explanatory view showing a case in which an ideal time code signal is processed in a first embodiment of the present invention.

FIG. 4 is an explanatory view showing a case in which the real time code signal is processed in the first embodiment of the present invention.

FIGS. 5A to 5C are explanatory views showing the summary of a second embodiment of the present invention.

FIG. 6 is an explanatory view showing an application example when sampling data are a binary code 0 in the second embodiment of the present invention.

FIG. 7 is an explanatory view showing an application example when the sampling data are a binary code 1 in the second embodiment of the present invention.

FIG. 8 is an explanatory view showing an application example when the sampling data are a marker code in the second embodiment of the present invention.

FIG. 9 is a table showing the situation of a pulse code judgment with respect to an average value of a matching score in the second embodiment.

FIG. 10 is a table showing the situation of the pulse code judgment with respect to a minimum value of the matching score in the second embodiment.

FIGS. 11A to 11E are explanatory views showing the summary of a third embodiment of the present invention.

FIG. 12 is an explanatory view showing an application example when the sampling data are a binary code 0 in the third embodiment of the present invention.

FIG. 13 is an explanatory view showing an application example when the sampling data are a binary code 1 in the third embodiment of the present invention.

FIG. 14 is an explanatory view showing an application example when the sampling data are a marker code in the third embodiment of the present invention.

FIG. 15 is a table showing the situation of the pulse code judgment with respect to an average value of the matching score in the third embodiment.

FIG. 16 is a table showing the situation of the pulse code judgment with respect to a minimum value of the matching score in the third embodiment.

FIG. 17 is a table showing the difference between maximum and minimum values of the matching score in the second embodiment.

FIG. 18 is a table showing the difference between maximum and minimum values of the matching score in the third embodiment.

FIGS. 19A to 19E are explanatory views showing application examples when the sampling data are a binary code 0 in a fourth embodiment of the present invention.

FIGS. 20A to 20E are explanatory views showing application examples when the sampling data are a binary code 1 in the fourth embodiment of the present invention.

FIGS. 21A to 21E are explanatory views showing application examples when the sampling data are a marker code in the fourth embodiment of the present invention.

FIGS. 22A to 22D are explanatory views showing application examples when the sampling data are a binary code 0 in a fifth embodiment of the present invention.

FIGS. 23A to 23D are explanatory views showing application examples when the sampling data are a binary code 1 in the fifth embodiment of the present invention.

FIGS. 24A to 24D are explanatory views showing application examples when the sampling data are a marker code in the fifth embodiment of the present invention.

### DESCRIPTION OF THE PREFERRED EMBODIMENTS

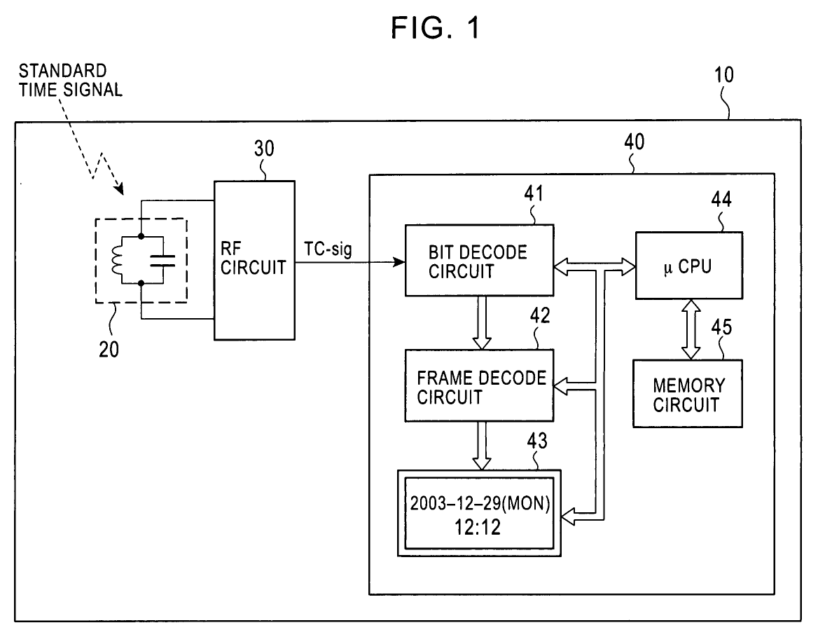

A first embodiment of a radio controlled clock and a time code decoding method in the present invention will be explained on the basis of the block diagram shown in FIG. 1. An object of this embodiment is to realize exact bit synchronization of a code pulse included in a time code signal.

As shown in FIG. 1, the radio controlled clock 10 based on this embodiment is mainly constructed by an antenna 20, a radio frequency circuit 30 and a main processing circuit 40. Further, the main processing circuit 40 includes various circuits such as a bit decode circuit 41, a frame decode circuit 42, a display circuit 43, a microprocessor 44, a memory circuit 45, etc. In addition to this, for example, the radio controlled clock 10 includes various circuits such as a power circuit, an operation inputting circuit, etc. However, these circuits do not directly relate to the embodiment of the present invention. Therefore, their descriptions and explanations are omitted here.

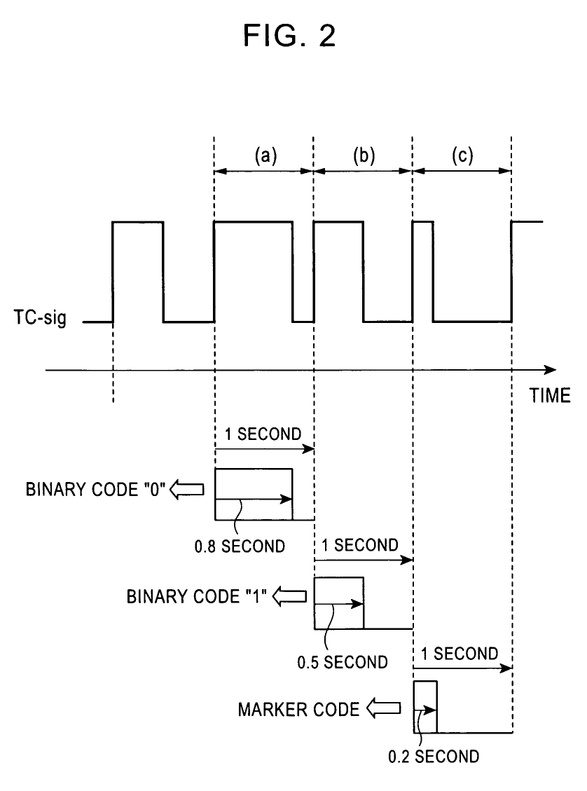

Each constructional element of the radio controlled clock 10 and its operation will next be explained. For example, the antenna 20 is a long radio wave signal receiving antenna such as a loop antenna, etc. The antenna 20 receives a standard time signal and supplies this standard time signal to the high frequency circuit 30. The high frequency circuit 30 amplifies and detects such a receiving radio wave, and extracts a time code signal (TC-sig) superposed on the standard time signal and supplies this signal to the main processing circuit 40. Here, FIG. 2 shows one example of a time series pulse constituting the time code signal (TC-sig). In this figure, since an interval (a) is constructed by “H” of 0.8 second and “L” of 0.2 second, this pulse is a pulse indicating a binary code “0” as mentioned above. Similarly, since an interval (b) is constructed by “H” of 0.5 second and “L” of 0.5 second, this pulse is a pulse indicating a binary code “1”. An interval (C) shows a pulse of a marker code constructed by “H” of 0.2 second and “L” of 0.8 second.

The bit decode circuit 41 judges pulses included in the pulse series of the time code signal, and decodes each pulse to each code of the binary “0”, the binary “1” or the marker. The frame decode circuit 42 at the next stage restores time information such as year, month, day, hour, minute, etc. included in the time code signal on the basis of each of these decoded codes. For example, the display circuit 43 displays such restored time information by using a display element such as LED, a liquid crystal display, etc.

The microprocessor 44 is constructed by a microprocessor of e.g., 16 bits, 32 bits, etc. and its peripheral circuit, and generalizes and controls the operation of each constructional element included in the main processing circuit 40, and is connected by each of the above circuits and a bus line. For example, the memory circuit 45 is constructed by an unillustrated memory element such as RAM, ROM, etc. A program prescribing various kinds of software processings executed by the microprocessor 44 is stored to the ROM. Various kinds of data supplied in an arithmetic calculation in these software processings are stored and held in the RAM. The decoding processing of the time code signal based on this embodiment is mainly performed in the bit decode circuit 41 under the control of the microprocessor 44.

The decoding processing of the time code signal in this embodiment will next be explained. First, the bit decode circuit 41 starts sampling of the time code signal supplied from the high frequency circuit 30 with a predetermined starting point position as a reference. For example, such a starting point position may be calculated from the rise of a standard time signal firstly received, or may be also calculated by utilizing a special calling-out code included in the standard time signal, etc. in a synchronizing signal. The receiving radio wave utilized in the calculation of the starting point position is set to be abandoned.

In this embodiment, the sampling period of the time code signal is set to 50 milliseconds, and the sampling is performed in a ratio of 20 bits/second. Sampling data are sequentially stored to the memory circuit 45 and are partitioned every one second, and a sampling data group constructed by 20 samples is collected as one data block. In this embodiment, generation processing of such a data block is called “list formation”.

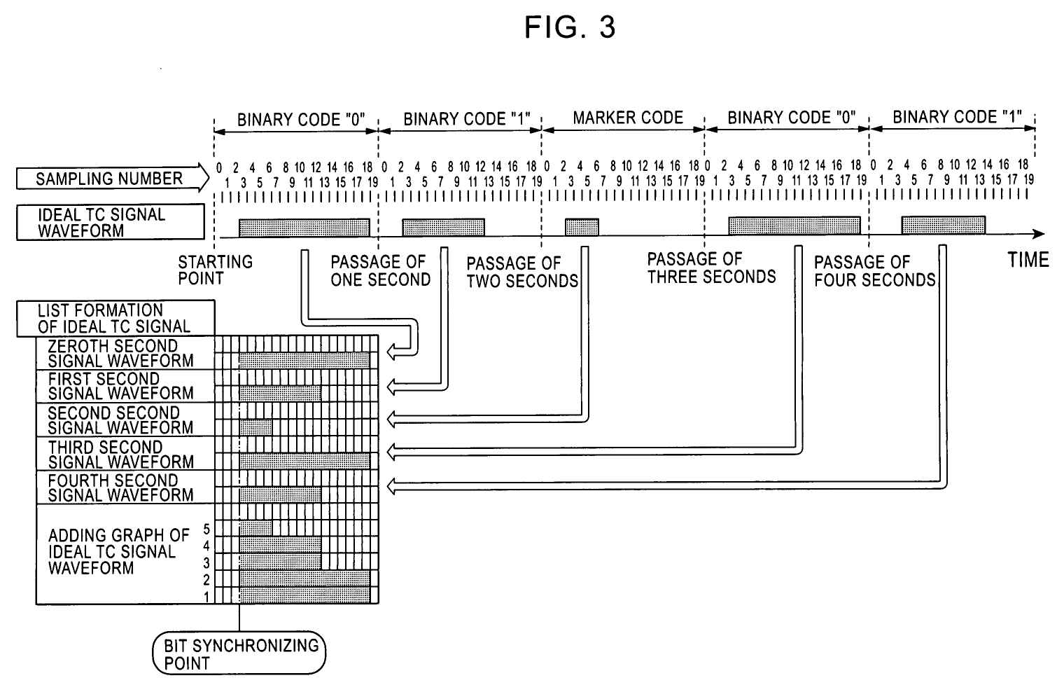

Here, FIG. 3 shows an example in which the time code signal (hereinafter called an “ideal TC signal”) having no influence of noise mixture and waveform distortion is sampled and is formed as a list. The time series of a pulse code included in the time code signal shown in this figure shows “ . . . →“binary 0”→“binary 1”→“marker”→“binary 0” “binary 1”→ . . . ”, and a case of the list formation with respect to five sampling data groups is shown. The value of a sampling rate and the number of sampling data groups formed as a list are not limited to the numerical values shown in this example.

In the case of the ideal TC signal, there is no influence of the noise mixture and the waveform distortion. Therefore, the rise positions (hereinafter called “bit synchronizing points”) of the respective pulse waveforms are conformed to each other with respect to each of the binary code “0”, the binary code “1” and the marker code. Therefore, all the levels of the pulse waveforms of the respective codes are simultaneously changed from “L” to “H” at such bit synchronizing points. Data every each sampling point are added with respect to its longitudinal direction in the sampling data group formed as a list in this embodiment so as to clarify this bit synchronizing point. In FIG. 3, the added sampling data are shown in the column of an “ideal TC signal waveform adding graph”.

In this connection, the adding data shown in FIG. 3 become an adding value (level 5) of all the codes for 0.2 second (corresponding to four samples) from the bit synchronizing point. Thereafter, the adding data become an adding value (level 4) of the binary “0” and the binary “1” for 0.3 second (corresponding to six samples). Further, thereafter, the adding data become an adding value (level 2) of only the binary code “0” for 0.3 second (corresponding to six samples). Thus, the adding data shown in FIG. 3 becomes a stepwise graph.

No amplitude change of the stepwise graph at the bit synchronizing point is changed even when the constructions of the codes included in the pulse series of the ideal TC signal are different from each other, i.e., even when the distributions of the binary code “0”, the binary code “1” and the marker code within the time code signal are different from each other. Namely, this amplitude is changed at a stroke from a minimum value 0 to a maximum value 5 at the bit synchronizing point. Therefore, the bit synchronizing point of each code pulse included in the time code signal can be reversely demarcated by detecting such a maximum changing point. Further, the sampling starting point can be also corrected with the demarcated bit synchronizing point as a reference.

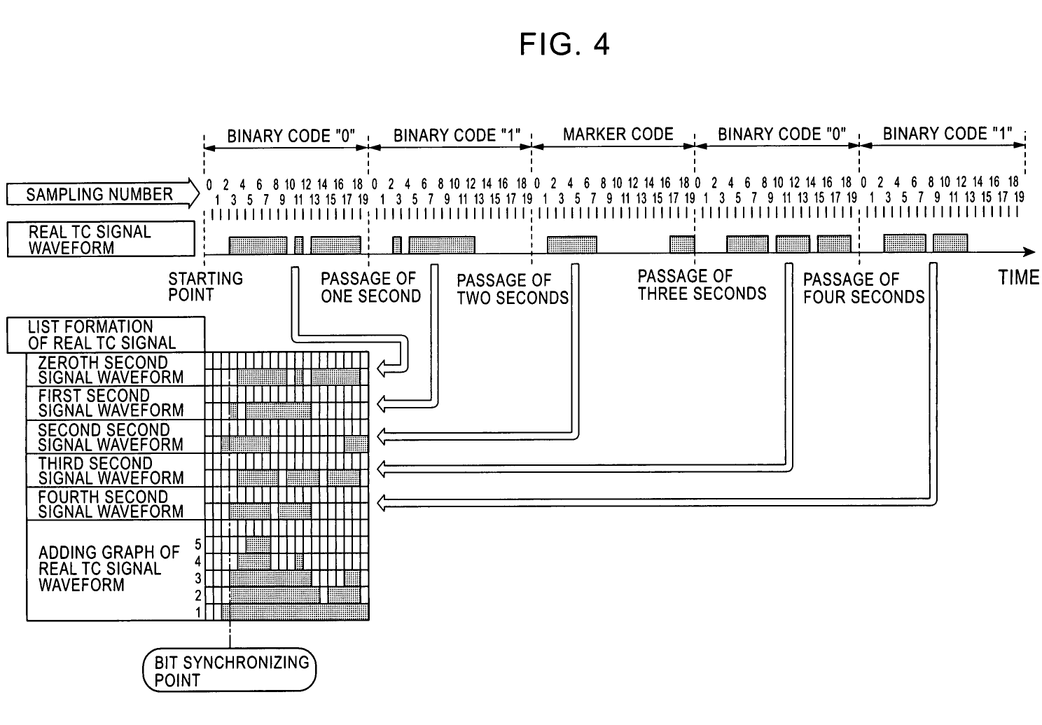

Next, processing in a treating case of the time code signal (hereinafter called “the real TC signal”) causing the noise mixture and the waveform distortion in this embodiment will next be explained on the basis of FIG. 4. The time series of the pulse code included in the time code signal of FIG. 4 shows “binary 0”→“binary 1”→“marker”→“binary 0”→“binary 1”→ . . . ” similarly to the case of the above ideal TC signal. However, a spike and dispersion of the pulse rise position are caused in this pulse time series by the mixture of noises and the waveform distortion due to the deterioration of a signal receiving state. Therefore, when the real TC signal is formed as a list, dispersion is recognized in the list formation waveform in comparison with the case of the ideal TC signal. The adding graph generated from such list formation waveform also becomes a distorted stepwise shape in comparison with the case of the ideal TC signal.

However, the rise position of each code pulse included in the real TC signal is originally the same position as the code included in the ideal TC signal, and such a rise position is changed by the noise mixture and the waveform distortion. Accordingly, if it is supposed that the change of the rise position due to disturbance of noises, etc. is caused at random, a maximum changing point of the adding graph obtained by forming the real TC signal as a list and adding the real TC signal is similar to that in the case of the ideal TC signal without waiting for a statistical analysis.

In FIG. 4, if the shape of this adding graph is analyzed, the stepwise graph is changed from level 0 to level 1 in third sampling from the starting point, and is also changed from level 1 to level 3 in fourth sampling. Further, the stepwise graph is respectively changed to levels 4 and 5 in the next fifth and sixth samplings. Namely, the maximum change of the adding graph appears in the fourth sampling from the starting point. Accordingly, similar to the case of the ideal TC signal, if the maximum changing point of the adding graph is detected, this point becomes the bit synchronizing point in the case of the real TC signal.

As mentioned above, in this embodiment, the sampling data of the time code signal are formed as a list in the period of one second, and a plurality of data groups formed as a list are added every sampling point. A rising edge for changing the adding result level at its maximum is then detected and is set to the bit synchronizing point, and the bit synchronization of the pulse signal included in the time code signal is demarcated.

In this embodiment, the bit synchronizing point is detected by adding the listed data groups five times. However, the number of adding calculations is not limited to such an example, but detecting accuracy of the bit synchronizing point can be improved as the number of adding calculations is increased.

A second embodiment of the present invention will next be explained. The construction of a radio controlled clock relating to the second embodiment is similar to that relating to the first embodiment. Therefore, the description and explanation of this construction are omitted here.

An object of this embodiment is to prevent a situation in which the normal decode of each code is prevented by the mixture of noises and the waveform distortion. Namely, the object of this embodiment is to reliably decode each code of one bit included in the time code signal to each of the binary code “0”, the binary code “1” or the marker code. As a premise for realizing this embodiment, it is set to a condition that the bit synchronizing method explained in the first embodiment is executed and the sampling data of the time code signal established in the bit synchronization are formed as a list.

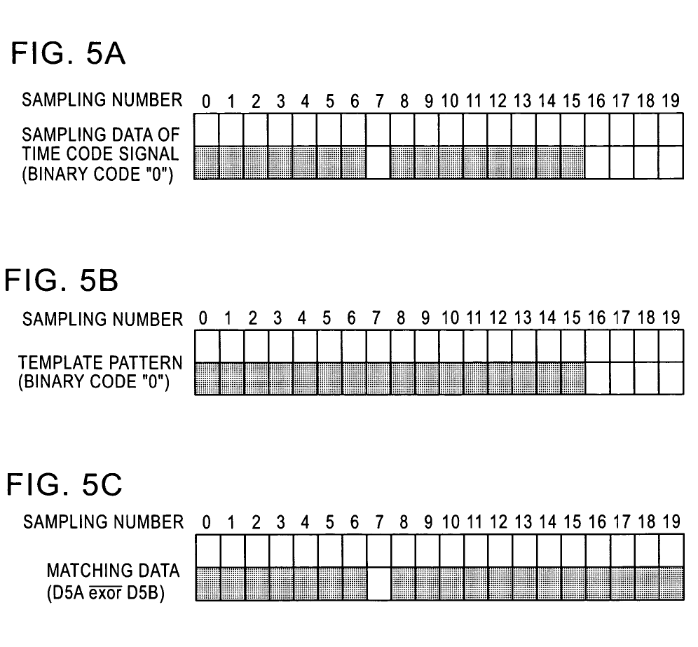

The basic concept of this embodiment will first be explained in FIG. 5. FIG. 5A shows data of binary “0” sampled from the time code signal and formed as a list. FIG. 5B shows a template pattern (described later in detail) of binary “0”. FIG. 5C shows matching data derived by arithmetically processing waveforms D5A, D5B shown in the above FIGS. 5A and 5B. In this embodiment, the bit synchronization in the first embodiment is completed with respect to the sampling data of the time code signal, and the sampling of the data is set to be started from the starting point of the bit synchronization.

It is supposed that a seventh sampling value has been changed from level “H” to level “L” by the influence of the noise mixture and the waveform distortion with respect to the sampling data of the binary code “0” shown in FIG. 5A. Further, the template pattern shown in FIG. 5B shows a bit pattern in which a pulse waveform (level “H” for 0.8 second and level “L” for 0.2 second) indicating the binary code “0” is sampled by 20 bits/second. Further, in the matching data of FIG. 5C, a point for conforming the sampling data of FIG. 5A and the template pattern of FIG. 5B is set to “1” and a point of nonconformity is set to “0”. Namely, the matching data of FIG. 5C show an inverting value of the exclusive OR of the sampling data and the template pattern.

In this embodiment, the total of point numbers set to “1” in such matching data is defined as a matching score, and is set to an index indicating the strength of correlation of the sampling data and the template pattern. Namely, when the sampling data are perfectly conformed to the template pattern, the matching score shows a maximum value of 20. In contrast to this, when there is no conforming point of the sampling data and the template pattern at all, the matching score becomes a minimum value of 0. The matching score of the examples shown in FIGS. 5A to 5C becomes 19, and can be judged as 95% of conformity with respect to the matching score 20 in which all the points are conformed to each other.

In this embodiment, the matching score is similarly judged with respect to the template pattern of each of binary code “1” and the marker code, and the template pattern indicating a largest matching score is judged as a code closest to these sampling data.

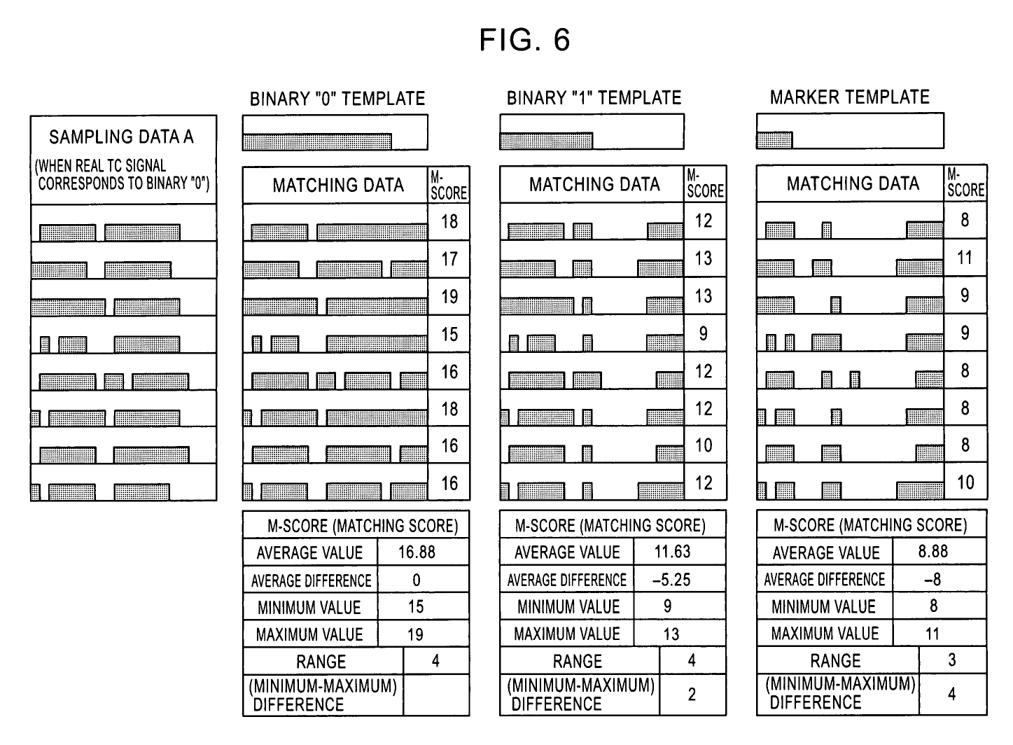

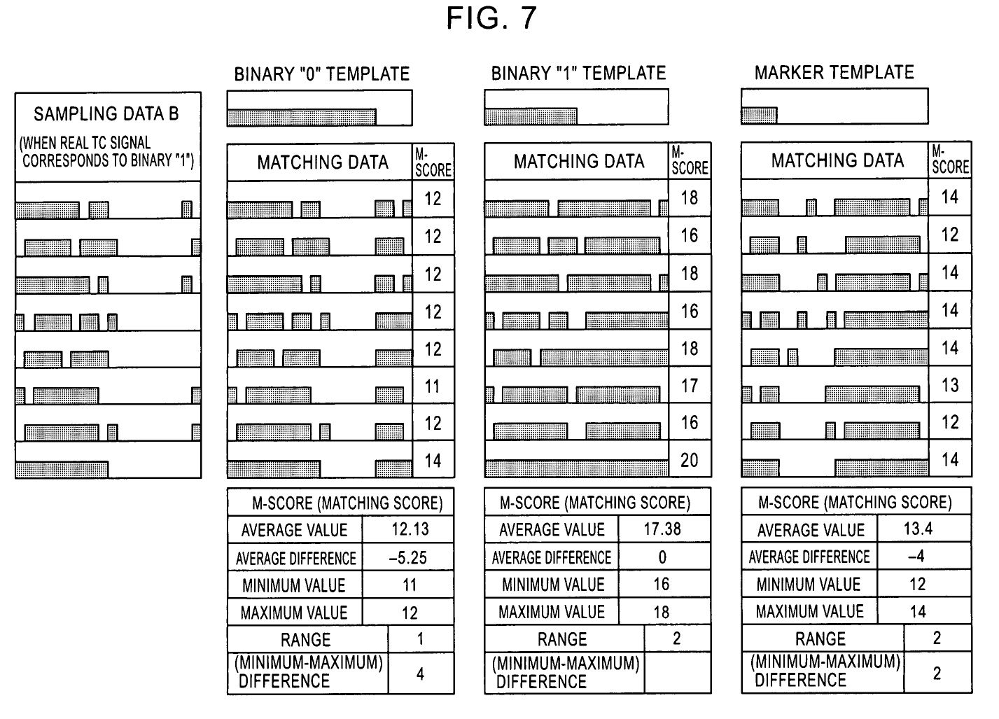

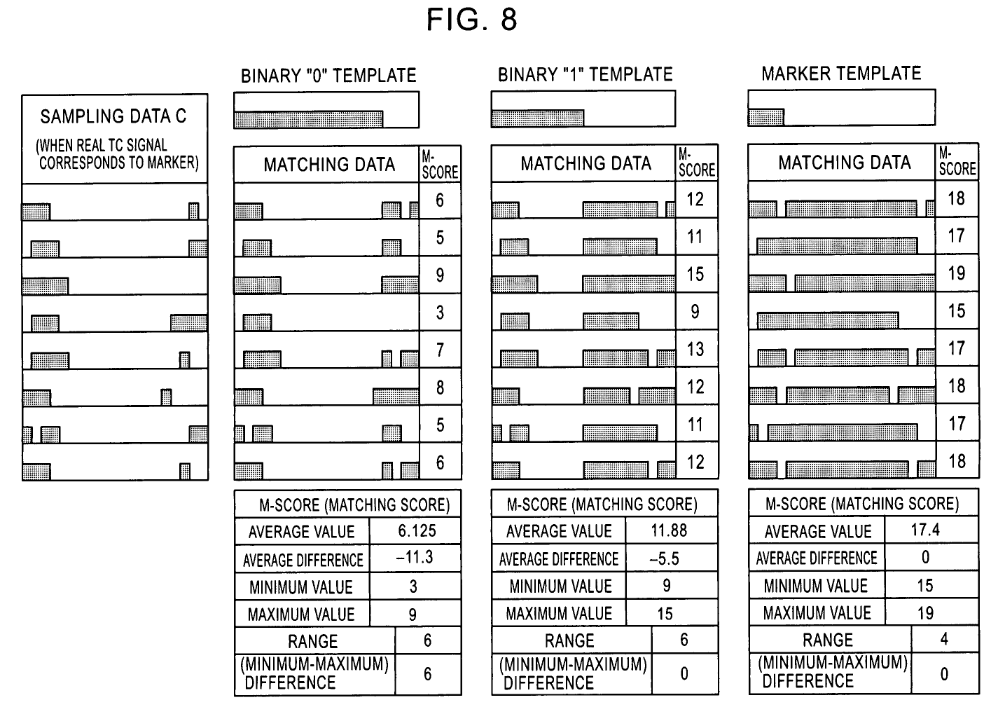

Applications of the code judgment processing based on this embodiment are shown in FIGS. 6 to 8. FIGS. 6 to 8 show cases in which the sampling data respectively correspond to the binary “0”, the binary “1” and the marker. The sampling data in the respective cases are set to sampling data A, sampling data B and sampling data C. In each of these figures, the code judgment processing is performed with respect to eight sampling data. The matching score about three kinds of template patterns constructed by the binary “0”, the binary “1” and the marker is calculated with respect to one sampling data. Further, with respect to the matching score calculated about the eight sampling data, various values such as its average value, etc. are calculated together.

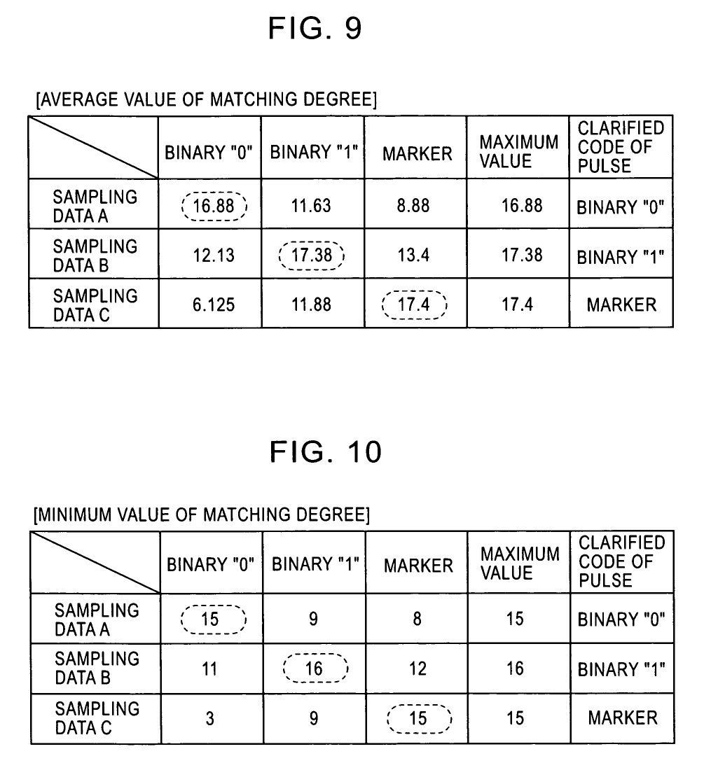

FIGS. 9 and 10 show its calculating results and the maximum matching score with respect to each code. As can be seen from the tables shown in both FIGS. 9 and 10, it is possible to distinguish each code from the average value or the minimum value of the matching score.

As explained above, in accordance with this embodiment, the matching score of a predetermined template pattern and the sampling data of the real TC signal is utilized in the judgment of the code included in the time code signal. Therefore, it is possible to reduce the degree of an incorrect judgment due to the influence of the mixture of noises and the waveform distortion.

A third embodiment of the present invention will next be explained. The construction of a radio controlled clock relating to the third embodiment is similar to that relating to the first embodiment. Therefore, the description and explanation of its construction are omitted here. Further, as a premise for realizing this embodiment, it is supposed that the bit synchronizing method explained in the first embodiment is executed, and the sampling data of the time code signal established in the bit synchronization are formed as a list, and the code judging method (hereinafter called a “simple bit pattern judgment”) using the template of the second embodiment is executed.

An object of this embodiment is to prevent a situation in which the normal decode of each code is prevented by the mixture of noises and the waveform distortion, and further improve the code judging ability explained in the second embodiment.

In the decoding method using the simple bit pattern judgment of the second embodiment, the code judgment was simply made by evaluating the matching score of the sampling data and the template pattern. However, in the real radio controlled clock, the time code signal supplied from the high frequency circuit 30 is transmitted via filtering processing, etc. using a low frequency pass filter within this circuit. Therefore, for example, there are many cases having a specific tendency in which jitter is caused in change timing from “L” to “H” or from “H” to “L” in the pulse waveform included in the time code signal, etc.

Therefore, if such a specific tendency caused in the time code signal is removed, the code judging result using the above matching score naturally becomes further preferable. In this embodiment, such a specific tendency is excluded by performing predetermined mask processing with respect to the sampling data of the time code signal.

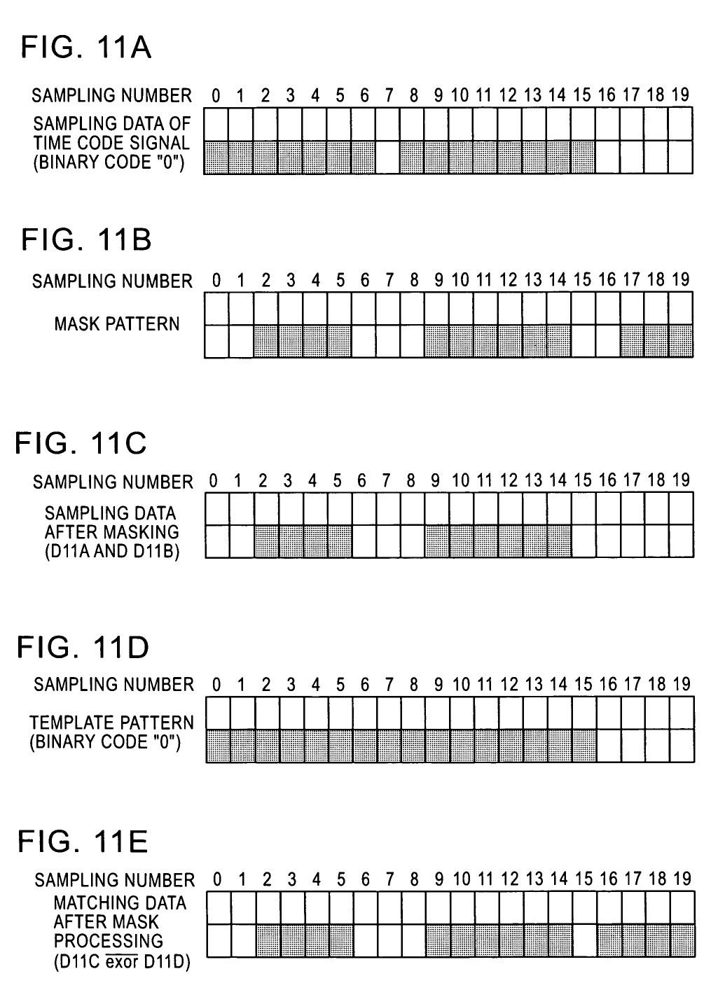

The basic concept of this embodiment will be explained on the basis of FIGS. 11A to 11E. Similar to the case of the second embodiment, the sampling data of the time code signal in these figures are set to the binary code “0” in which the waveform distortion of one point (seventh sampling point) is caused. In the sampling data, the bit synchronization is demarcated by the processing of the first embodiment, and the sampling is set to be started from the starting point of the bit synchronization.

In this embodiment, masking using the mask pattern of FIG. 11B is first performed with respect to the sampling data of the time code signal shown in FIG. 11A, and the sampling data after the masking shown in FIG. 11C are calculated. Namely, both logic product data are generated and are set to the sampling data after the masking of FIG. 11C so as to extract only a conforming portion of the sampling data D11A of FIG. 11A and the mask pattern D11B of FIG. 11B. Then, the matching score is detected by using the template pattern D11D of FIG. 11D with respect to the sampling data D11C after such masking, and the sampling data are judged as to whether the sampling data shows any code. The detection of the matching score using the template pattern and the code judgment are similar to those in the case of the second embodiment. Therefore, their explanations are omitted here.

For example, the mask pattern shown in FIG. 11B may be made by a simulation using a computer on the basis of transmission characteristics within the high frequency circuit of the radio controlled clock 10, or may be also made by a statistical technique by collecting and analyzing the waveform distortion caused in the real sampling data.

For example, in FIG. 6 showing the decoding method using the simple bit pattern judgment of the second embodiment, constant tendencies shown below are found when eight sampling data are observed when the real TC signal corresponds to the binary “0”.

(1) There is a tendency in which timing of the signal level changed from “L” to “H” from the bit synchronizing point is dispersed in accordance with data.

(2) There is a tendency in which the level “L” is generated near the center of the period of the level “H” with respect to the signal.

(3) There is a tendency in which timing of the signal level changed from “H” to “L” is dispersed in accordance with data.

Accordingly, it is considered that sampling intervals having the above tendencies are inappropriate to perform the matching with the template pattern. Therefore, the mask pattern is set so as to exclude these intervals. FIG. 11B shows one example of the mask pattern generated under such a plan. Therefore, with respect to the mask pattern in this embodiment, various mask patterns are considered every each code or in accordance with the specification of the radio controlled clock and its using state.

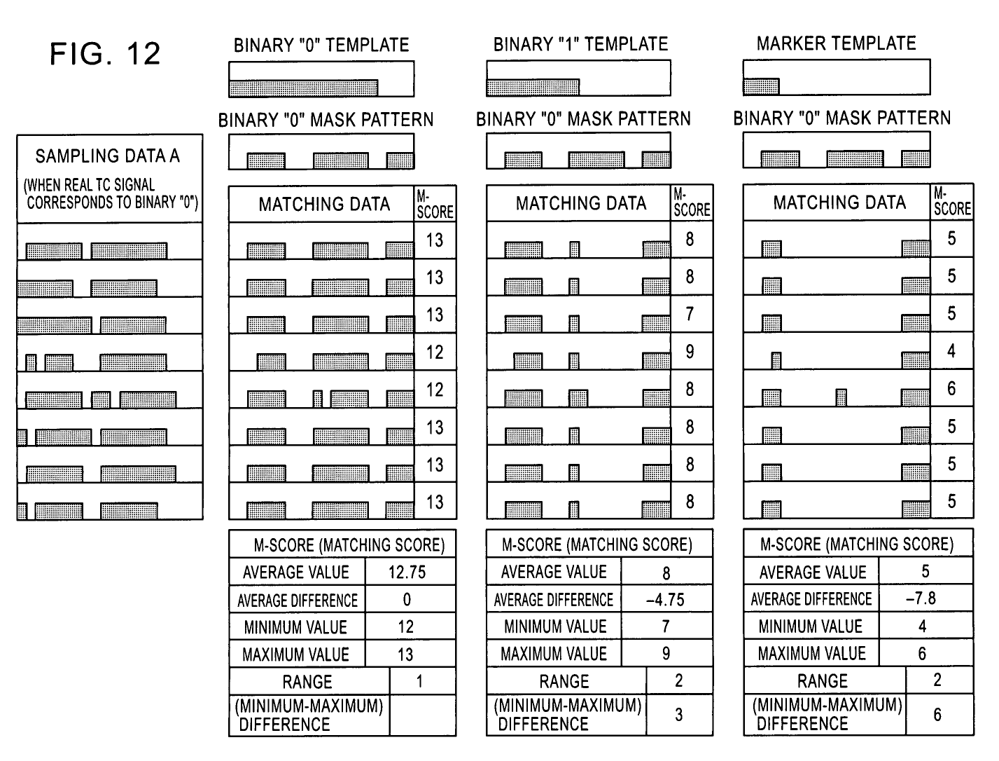

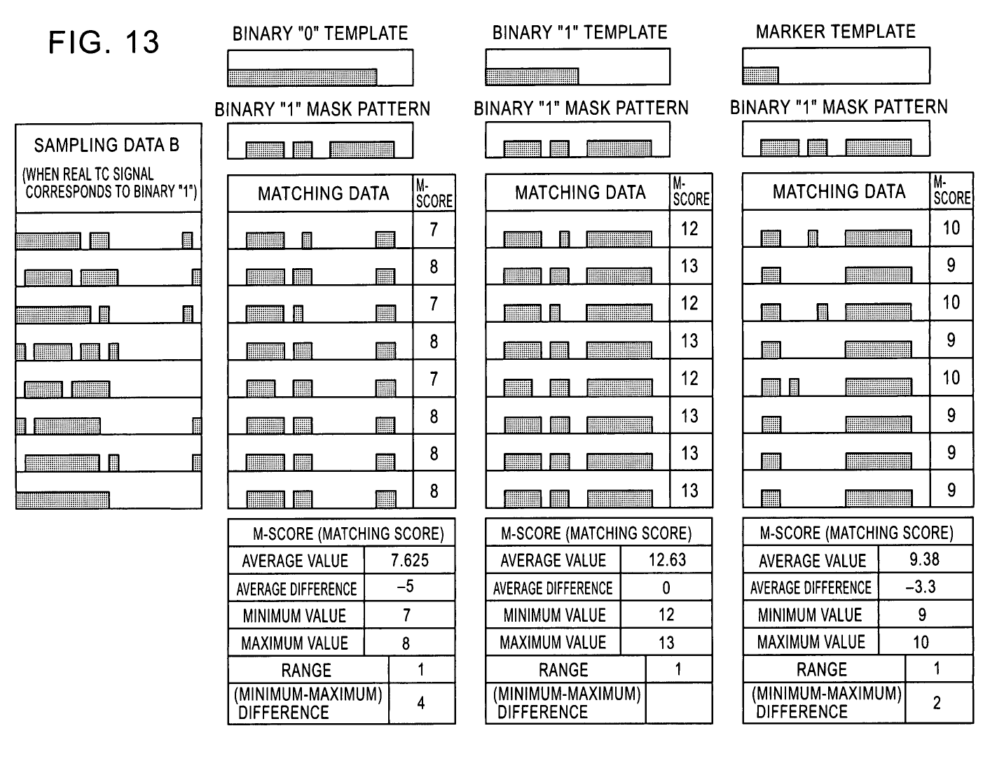

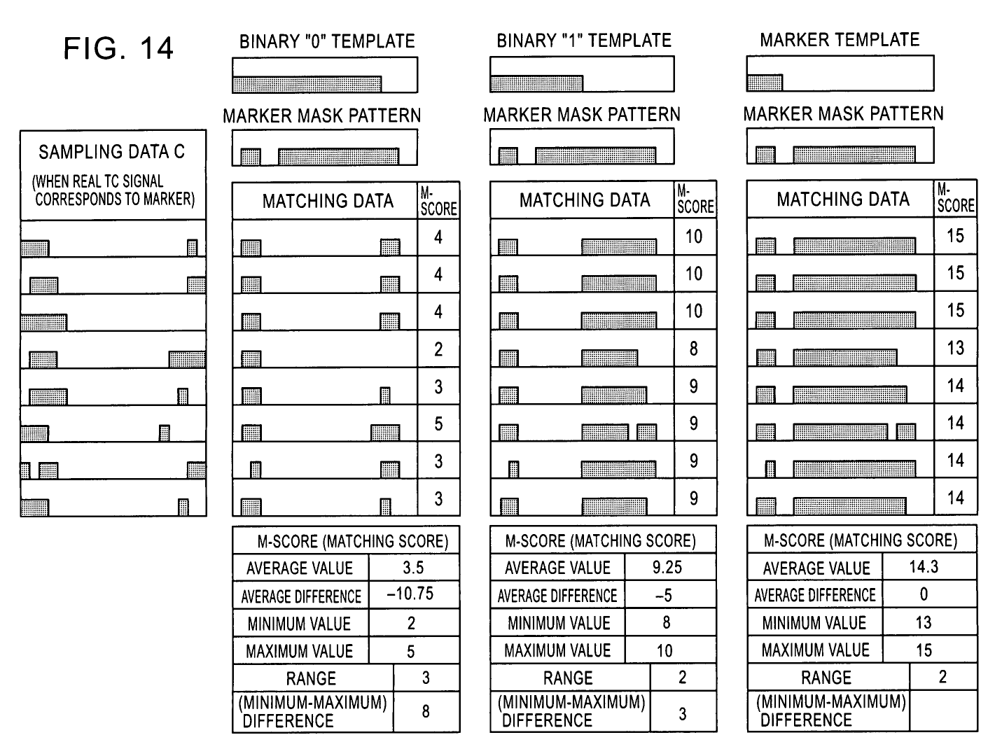

FIGS. 12 to 14 show application examples in which the mask pattern with respect to each code is prescribed similarly to the case of the sampling data of the binary “0” explained above. FIG. 12 shows a case in which the sampling data of the binary “0” are supposed. FIG. 13 shows a case in which the sampling data of the binary “1” are supposed. FIG. 14 shows a case in which the sampling data of the marker are supposed. These sampling data are the same as the sampling data used in FIGS. 6 to 8 of the second embodiment.

In these application examples, a logic product with respect to each mask pattern of binary 0/binary 1/marker is calculated with respect to one sampling data, and three matching data with respect to each template are calculated. Further, with respect to the matching score calculated with respect to eight sampling data, various values such as its average value, etc. are calculated together.

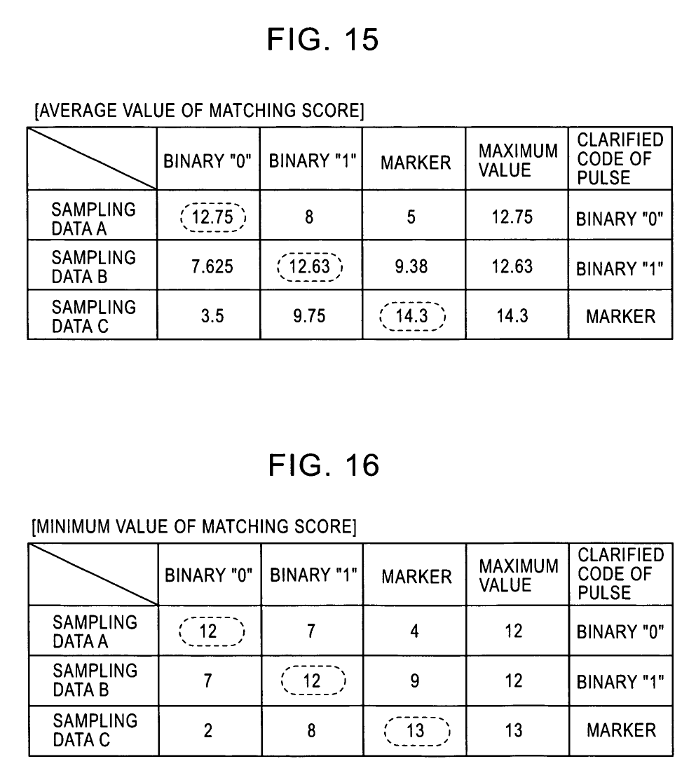

With respect to the above calculating results, a maximum matching score and a code corresponding to this matching score are shown in the respective tables of FIGS. 15 and 16.

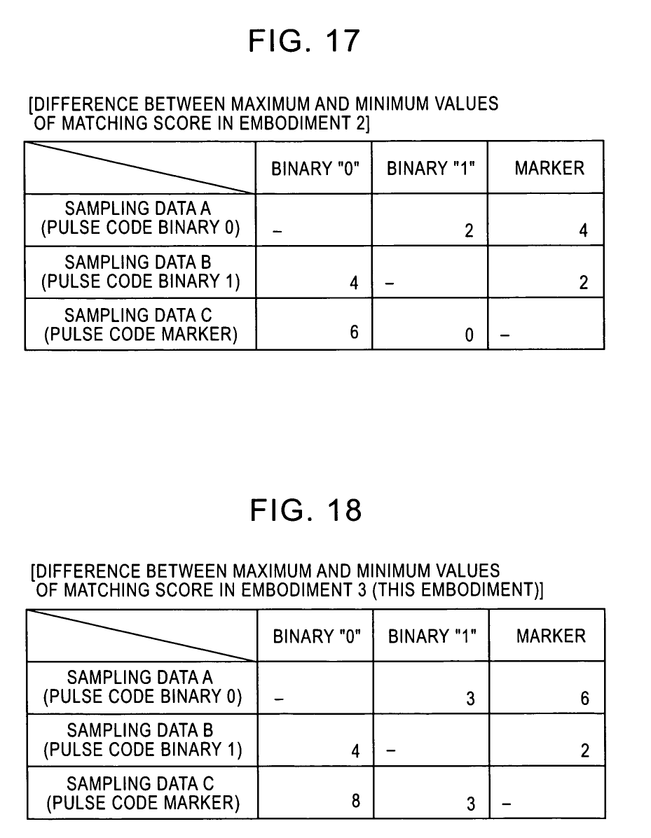

The difference between the maximum and minimum values of the matching score in this embodiment and the second embodiment is shown in each of the tables of FIGS. 17 and 18 to perform comparison with the results in this embodiment.

As can be seen from such comparison results, the dispersion of the matching score of the sampling data is reduced by performing the mask processing in this embodiment. Accordingly, it is possible to further reduce the degree of an incorrect judgment of the pulse code due to the influence of the noise mixture and the waveform distortion.

A fourth embodiment of the present invention will next be explained. The construction of a radio controlled clock relating to the fourth embodiment is similar to that relating to the first embodiment. Therefore, the description and explanation of its construction are omitted here. Further, when this embodiment is realized, it is premised that the above processings of each embodiment are performed.

In the second and third embodiments, the template pattern used to calculate the matching score and the mask pattern used in the mask processing are set in advance every each code. However, in this embodiment, these patterns are generated from the sampling data.

In the third embodiment, a predetermined mask pattern is used to exclude a sampling point supposed to be large in the dispersion of the signal level from the object of the code judgment. Namely, the mask pattern becomes a pattern removing the point of large dispersion in the sampling data. In this embodiment, a standard deviation of the signal level at each sampling point is used as an evaluation reference value of the dispersion to evaluate the dispersion of data at such a sampling point.

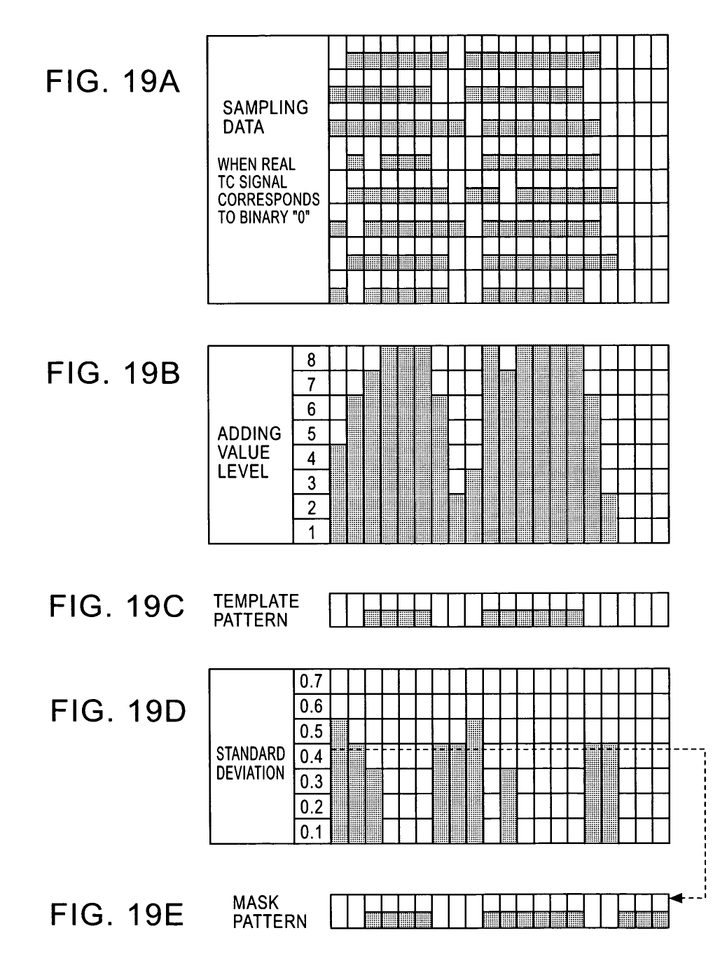

This embodiment will be explained by using FIGS. 19A to 19E adopting a case in which the real TC signal corresponds to the binary 0 as sampling data as an example. Eight sampling data shown in FIG. 19A are the same as the sampling data shown in FIG. 6 of the second embodiment and FIG. 12 of the third embodiment.

In this embodiment, the standard deviation of the signal level at each sampling point from 0 to 19 with respect to the eight sampling data is first calculated. For example, when the sampling point 0 in FIG. 19A is noticed, each signal level of the eight sampling data is set to
0, 1, 1, 0, 0, 1, 0, 1
   from the uppermost stage. Accordingly, an adding value and an average value a of the signal level at the same point are respectively calculated as
   S=1+1+1+1=4
   a=S/8=4/8=0.5.

When the standard deviation σ at the same point is calculated by using the above various values, the standard deviation σ can be calculated as σ=0.5. FIG. 19D shows the value of the standard deviation at each sampling point calculated in this way.

Next, a threshold value as an evaluation reference value of the standard deviation is determined and a point indicating the standard deviation value of this threshold value or more is set as the mask pattern. FIG. 19D shows a case in which the standard deviation of 0.4 is determined as such a threshold value. FIG. 19E shows the mask pattern generated by this standard deviation. In this embodiment, the threshold value of the standard deviation is not naturally limited to such a value.

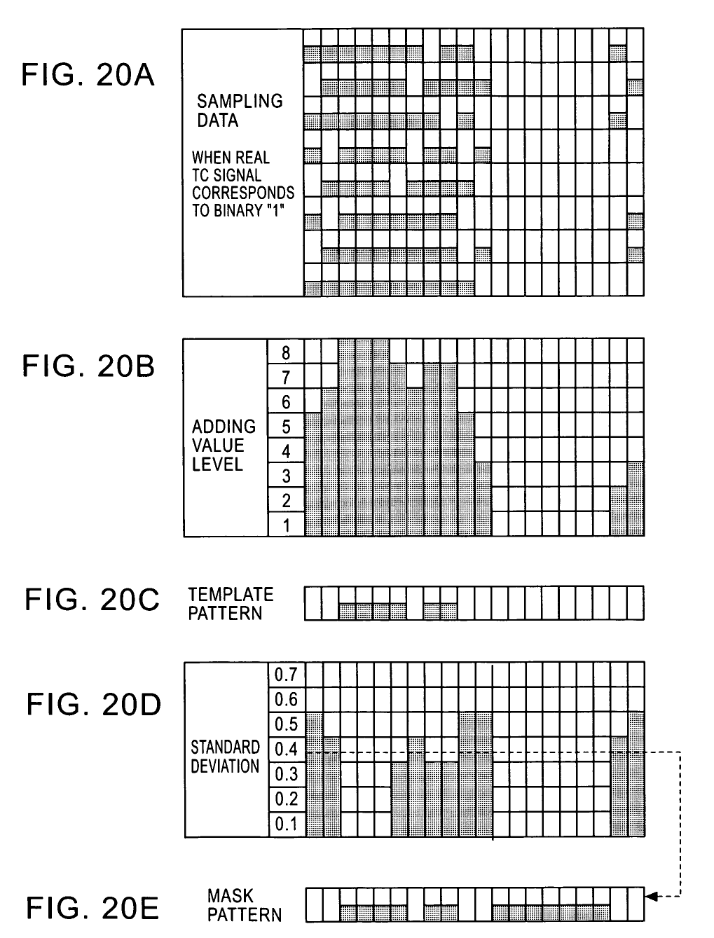

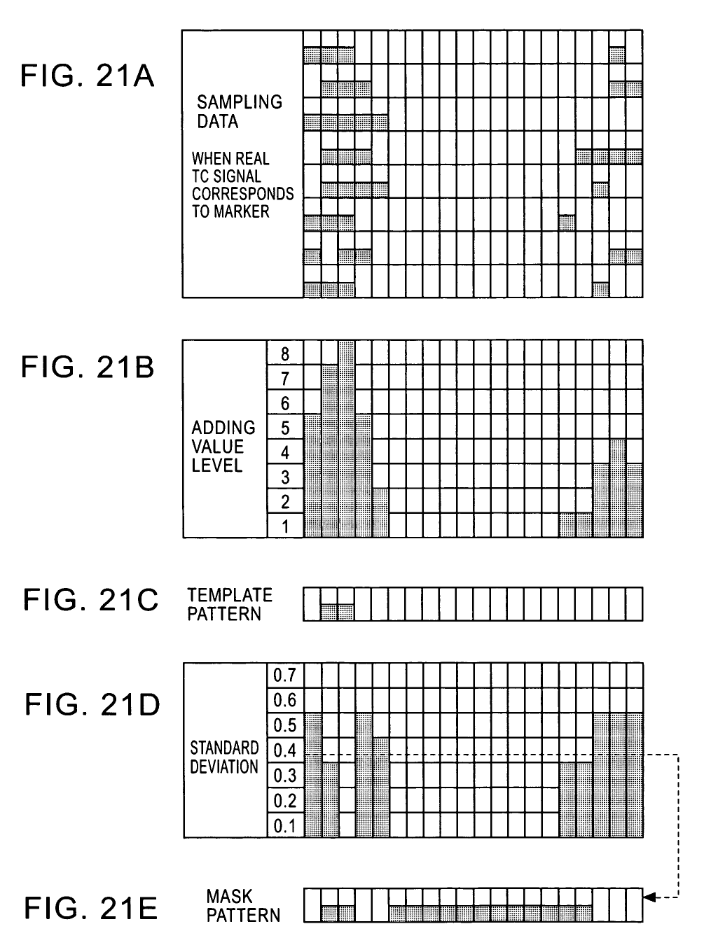

On the other hand, the template pattern is generated by a logic product of the adding value of the sampling data shown in FIG. 19B and the mask pattern generated in FIG. 19E. FIG. 19C shows the template pattern generated in the case of FIGS. 19B and 19E. In this embodiment, FIGS. 20A to 20E show application examples when the sampling data correspond to the binary code 1 of the real TC signal. FIGS. 21A to 21E show application examples when the sampling data correspond to the marker code.

As explained above, in accordance with this embodiment, the mask/template pattern following a signal receiving state can be generated from the received time code signal even when the signal receiving state of the standard time signal is changed. Accordingly, it is possible to decode the time code signal always adapted for the signal receiving state.

A fifth embodiment of the present invention will next be explained. The construction of a radio controlled clock relating to the fifth embodiment is similar to that relating to the first embodiment. Therefore, the description and explanation of its construction are omitted here. When this embodiment is realized, it is premised that the above processings of each embodiment are performed.

In the above fourth embodiment, the standard deviation of the signal level at each sampling point is used as a reference value for generating the mask pattern. However, it is necessary to calculate the average value of the signal level and the difference between each data and the average value and make a square arithmetic calculation of the difference, a sum total calculation and a divisional calculation using a data number, and then calculate its square so as to calculate the standard deviation. Therefore, there is a fear that an arithmetic processing burden in the microprocessor is increased and has an influence on the execution of other processings. An object of this embodiment is to generate the mask pattern and the template pattern by simple arithmetic processing in which no burden is born to the microprocessor.

Namely, in the fourth embodiment, the standard deviation of the sampling data is set to a reference of the mask pattern generation, but each sampling point value of each data is one of the two values of 0 and 1. When the dispersion is small, it is clear that the average value of the sampling point approaches 0 or 1. In this embodiment, the average value of the sampling point of each data is utilized in the judging reference in the mask pattern generation by noticing such characteristics.

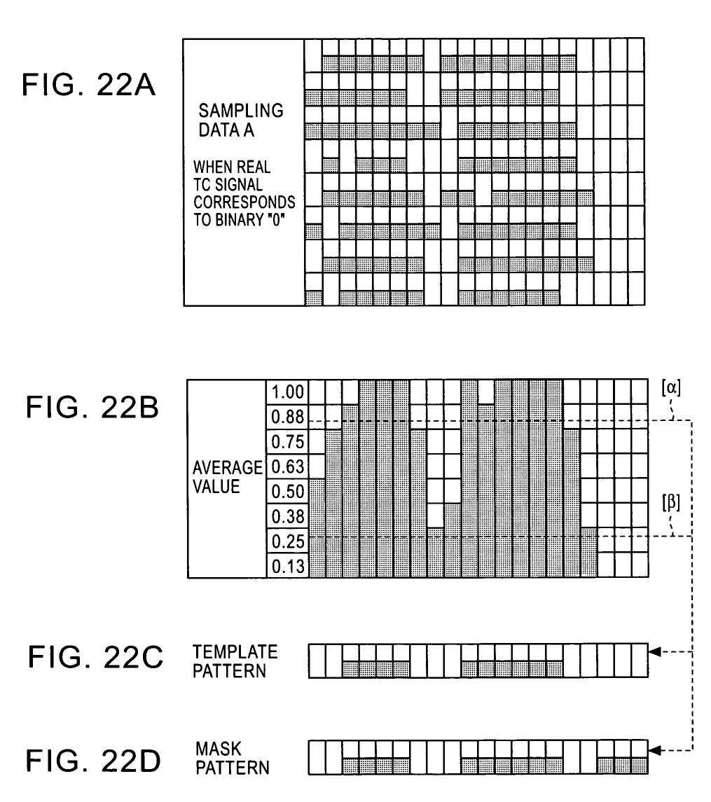

This embodiment will be explained by using FIGS. 22A to 22D by adopting a case in which the real TC signal corresponds to the binary 0 as the sampling data as an example. Eight sampling data shown in FIG. 22A are similar to those in the case of the fourth embodiment.

In this embodiment, the average value of each sampling data signal level at each sampling point from 0 to 19 is first calculated. FIG. 22B shows the calculating results of such an average value. Next, two threshold values of an upper limit threshold value [α] close to an average value level 1 and a lower limit threshold value [β] close to an average value level 0 are set with respect to the average value of FIG. 22B. In the example of FIGS. 22A to 22D, 0.75=6/8 is set as the upper limit threshold value, and 0.25=2/8 is set as the lower limit threshold value. However, the respective threshold values are not limited to such values.

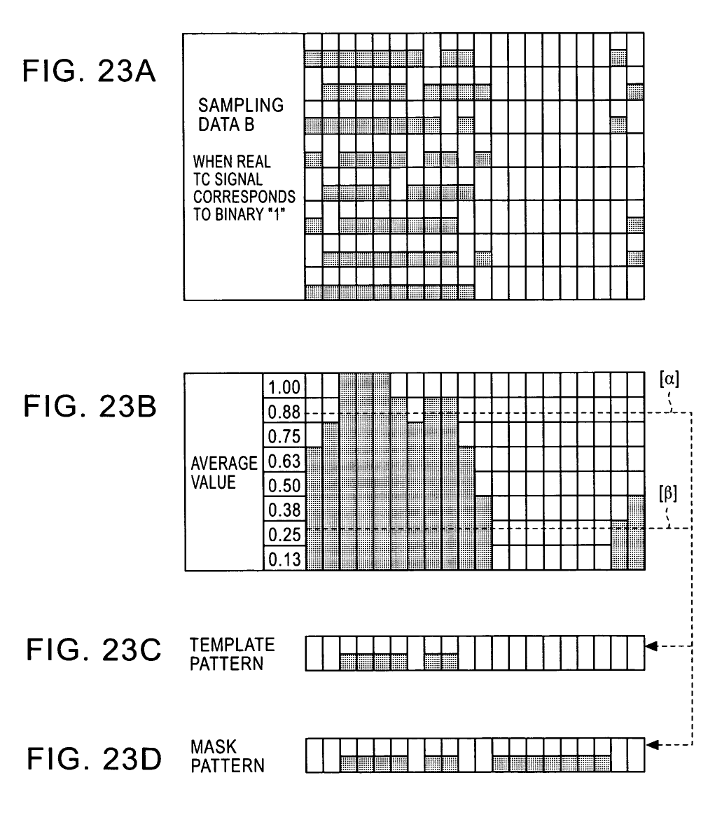

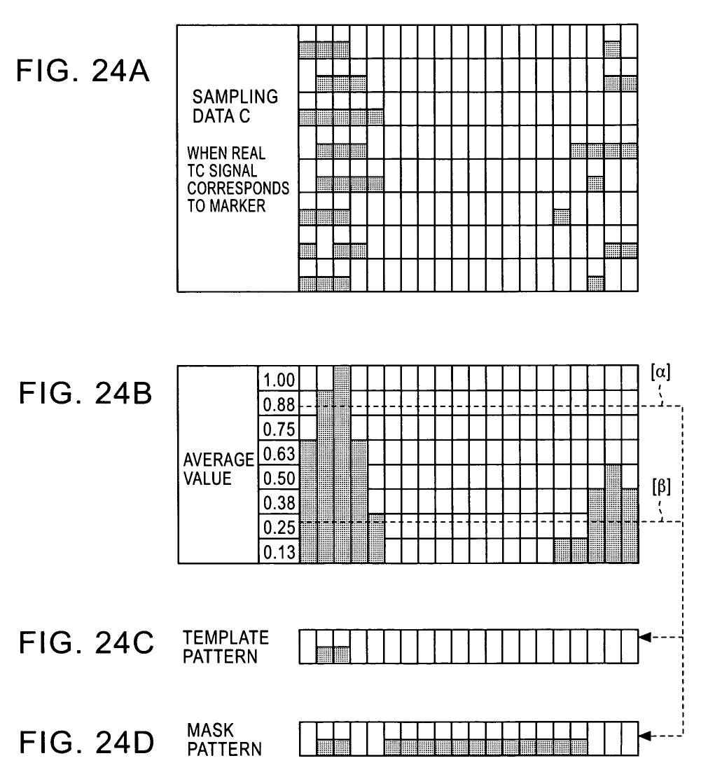

A point at which the signal level of the average_value lies within the range of both the threshold values is set to 0. A point at which this signal level lies outside this range is set to 1. Thus, the mask pattern shown in FIG. 22D is generated. Further, a point indicating an average value level exceeding the upper limit threshold value is set to 1, and a point except for this average value level is set to 0. Thus, the mask pattern shown in FIG. 22C is generated. In this embodiment, FIGS. 23A to 23D show application examples when the sampling data correspond to the binary code 1 of the real TC signal. FIGS. 24A to 24D show application examples when the sampling data correspond to the marker code.

In accordance with the simple generating method of the mask/template pattern in this embodiment, a mask/template pattern similar to that of the fourth embodiment can be generated without performing an arithmetic operation having the large burden of the standard deviation calculation of the sampling data. In the above explanation, the average value of the sampling data is used as the judging reference value, but an adding value of the sampling data may be also used as the judging reference value when the number of data is fixed. In this case, no divisional calculation for calculating the average value is required so that the arithmetic amount can be further reduced.

As explained above, in accordance with this embodiment, effects equal to those of each of said embodiments can be obtained by a small arithmetic amount. Further, since the arithmetic amount is small, no microprocessor having large processing ability is required and electric power consumption can be reduced.

This application is based on Japanese Patent Application No. 2004-061763 which is herein incorporated by reference.

1. A standard time signal receiving time device for decoding a time code signal as a pulse signal constructed by a series of pulses each indicating a code by its pulse width from a standard time signal, and comprising:
a sampling component for sampling said time code signal every sampling interval and generating a plurality of sampling data;
an adding component for adding said a plurality of sampling data every said each sampling interval and generating the sampling data adding value every each sampling interval; and
a reference point determining component in which the position of the sampling interval for maximizing the difference of a pair of said sampling data adding value corresponding to the respective sampling intervals adjacent to each other is determined as a bit synchronizing point.

2. The standard time signal receiving time device according to claim 1, wherein the standard time signal receiving time device further includes:
a correlation arithmetic component for calculating the correlation value between the width of the pulse obtained by extracting each pulse within said pulse signal by said sampling data and the pulse width indicating said code, and
a judging component for judging one code with respect to said pulse in accordance with said correlation value.

3. The standard time signal receiving time device according to claim 2, wherein said correlation arithmetic component performs masking using a predetermined mask pattern with respect to the pulse obtained by said extraction when said correlation value is calculated.

4. The standard time signal receiving time device according to claim 3, wherein the standard time signal receiving time device further includes a pattern generating component for generating the mask pattern and a template pattern from said pulse.

5. The standard time signal receiving time device according to claim 4, wherein said pattern generating component generates said mask pattern with the standard deviation of a signal level of said pulse as a reference, and generates said template pattern by calculating a multiplying product of said mask pattern and the adding value of the signal level of said pulse.

6. The standard time signal receiving time device according to claim 4, wherein said pattern generating component generates said template pattern and said mask pattern by setting upper and lower limit threshold values with respect to the average value of the signal level of said pulse, and combining said average value and said upper and lower limit threshold values.

7. A decoding method of a time code signal for decoding the time code signal as a pulse signal constructed by a series of pulses each indicating a code by its pulse width from a standard time signal, and comprising:
a sampling step for sampling said time code signal every sampling interval and generating a plurality of sampling data;
an adding step for adding said plurality of sampling data every said each sampling interval and generating the sampling data adding value every each sampling interval; and
a reference point determining step in which the position of the sampling interval for maximizing the difference of a pair of said sampling data adding value corresponding to the respective sampling intervals adjacent to each other is determined as a bit synchronizing point.

8. The decoding method of the time code signal according to claim 7, wherein the decoding method further includes:
a correlation arithmetic step for calculating the correlation value between the width of the pulse obtained by extracting each pulse within said pulse signal by said sampling data and the pulse width indicating said code, and
a judging step for judging one code with respect to said pulse in accordance with said correlation value.

9. The decoding method of the time code signal according to claim 8, wherein masking using a predetermined mask pattern is performed in said correlation arithmetic step with respect to the pulse obtained by said extraction when said correlation value is calculated.

10. The decoding method of the time code signal according to claim 9, wherein the decoding method further includes a pattern generating step for generating the mask pattern and a template pattern from said pulse.

11. The decoding method of the time code signal according to claim 10, wherein said mask pattern is generated with the standard deviation of a signal level of said pulse as a reference, and said template pattern is generated by calculating a multiplying product of said mask pattern and the adding value of the signal of said pulse in said pattern generating step.

12. The decoding method of the time code signal according to claim 10, wherein said template pattern and said mask pattern are generated in said pattern generating step by setting upper and lower limit threshold values with respect to the average value of the signal level of said pulse, and combining said average value and said upper and lower limit threshold values.
